(19) United States
(12) Patent Application Publication
(10) Pub. No.: US 2014/0260016 A1
(43) Pub. Date: Sep. 18, 2014

(54) FIRESTOP APPARATUS

(71) Applicant: LANCOTEK PRODUCTS INC., Halton Hills (CA)

(72) Inventors: Kevin B. Langille, Milton (CA); Thien T. Hoang, Mississauga (CA); Dat T. Nguyen, Oakville (CA)

(73) Assignee: Lancotek Products Inc., Halton Hills (CA)

(21) Appl. No.: 13/841,228

(22) Filed: Mar. 15, 2013

(51) Int. Cl. F16L 5/04

(52) U.S. Cl. CPC F16L 5/04
USPC 52/232

(57) ABSTRACT

A firestop apparatus includes a sleeve member having a sleeve opening extending between first and second ends and configured to receive a conduit member. The second end of the sleeve member has a sleeve member coupling portion with at least one sleeve fastener aperture. An intumescent collar member may be adjacent the second end of the sleeve member. The collar member has an opening aligned with the sleeve opening to receive the conduit member. The collar member is expandable from a non-expanded configuration to an expanded configuration, in which the intumescent collar material expands to seal against the conduit member. The collar member has at least one collar fastener aperture aligned with the at least one sleeve fastener aperture. At least one fastener passes through the at least one sleeve fastener aperture and the at least one collar fastener aperture to fasten the collar member to the sleeve member.

### FIELD

The present subject matter of the teachings described herein relates generally to firestop apparatuses that can be provided within partitions.

### BACKGROUND

U.S. Pat. No. 4,221,092 discloses a fire barrier comprising an intumescent composition packed into the space between a thermoplastic pipe and an access hole or duct in a wall or floor through which the thermoplastic pipe is laid. The intumescent composition is characterized in that it will expand on heating to temperatures at which the thermoplastic pipe melts or burns, to form a fire resistant mass. The intumescent compound is present in sufficient amounts to completely fill the access hole or duct in its expanded state.

U.S. Pat. No. 4,748,787 discloses a pipe flange fire-proofing kit and process for forming a cast-in fire-stop coupling from normal pipe includes a flange member which is separate from the normal pipe, annularly-shaped top and bottom spacer collars, and an annularly-shaped fire barrier collar. Each of these members is slid onto a pipe stub cut from a normal pipe with the top spacer collar being at a top end thereof, the bottom spacer collar being at a bottom end thereof, the fire-barrier collar of intumescent material being immediately adjacent the bottom spacer collar, and the flange member being between the fire barrier collar and the top spacer collar. The flange member is adhered to the pipe stub by an adhesive. The stub is attached to a concrete form wall onto which concrete to form a barrier is poured, with its bottom end and the bottom spacer being immediately adjacent the form wall so that upon curing of the concrete the top and bottom spacer collars can be removed so that female couplings can be attached to top and bottom ends of the pipe stub with the fire-barrier collar being open to air from the bottom side of the barrier. The pipe stub is attached to the form walls either by attaching members extending from the flange member to the form wall or by a compression column extending from the form wall through the pipe stub to the top end of the pipe stub.

U.S. Pat. No. 6,694,684 discloses a cast-in-place pass through firestop device for providing a passage in a partition through which wires, cables, pipes, and the like are run includes a housing having a riser portion with frangible connections that define removable bands that can be readily removed by a user to adjust the height of the device in accordance with the thickness of the partition into which the device is installed. The removable bands include pull tabs that provide grasping means to facilitate removal of the bands by a user along a frangible connection. The housing also includes a base portion including a recess with ribs for maintaining firestop material in spaced relation from the base portion sidewalk A flame retardant char forming material, which works in combination with the firestop material to provide a fire, smoke, and water barrier, may also be provided adjacent the firestop material.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

In accordance with one broad aspect of the teachings described herein, which may be used in combination with any other aspects, a firestop apparatus configured to be cast within a partition cast from a partition material may include a sleeve member. The sleeve member may extend along a sleeve axis and may have a first end, a second end axially spaced apart from the first end and a sleeve sidewall extending between the first and second ends. The sleeve member may have a sleeve opening extending between the first and second ends and may be configured to receive a conduit member. The second end of the sleeve member may include a sleeve member coupling portion having at least one sleeve fastener aperture. An intumescent collar member may be adjacent the second end of the sleeve member. The collar member may have a first collar end abutting the second end of the sleeve member, a second collar end axially spaced apart from the second collar end and a collar sidewall extending between the first and second collar ends. The collar member may have a collar opening to receive the conduit member. The collar opening may extend between the first and second collar ends, be bounded by a laterally inwardly facing collar inner surface and be aligned with the sleeve opening. The collar member may be formed from an intumescent material formed from a plurality of intumescent particles within a thermoplastic material and may be expandable from a non-expanded configuration to an expanded configuration, in which the intumescent collar material expands at least laterally inwardly to seal against the conduit member, when exposed to temperatures above an expansion temperature. The collar member may include at least one collar fastener aperture aligned with the at least one sleeve fastener aperture. At least one fastener may extend through the at least one sleeve fastener aperture and the at least one collar fastener aperture to fasten the collar member to the sleeve member.

The at least one fastener may extend along a fastener axis and the fastener axis may be substantially parallel to and laterally spaced apart from the sleeve axis.

The at least one fastener may be laterally outboard of the sleeve sidewall.

The collar member further may also include a plurality of reservoir projections extending laterally outwardly from collar sidewall and spaced apart from each other around the perimeter of the collar sidewall. Each reservoir projection may extend axially from the second collar end to a first reservoir projection end face positioned axially between the second collar end and the second sleeve end. One of the plurality of reservoir projections may include the at least one collar fastener aperture.

The coupling portion of the sleeve member may include a plurality of flanges extending generally laterally outwardly from the sleeve sidewall. Each flange may cover a portion of the first collar end and one flange comprises the at least one sleeve fastener aperture.

The combined volume of the reservoir projections may be between about 40% and about 60% of a total volume of the collar member.

At least a portion of a laterally outer surface of the collar member may be exposed to contact the partition material.

The sleeve sidewall may include a laterally outer surface to contact the partition material and at least one portion of the collar member may be disposed laterally outboard of the laterally outer surface of the sleeve sidewall.

The second collar end may include a second axial face and the at least one fastener may include a head portion positioned adjacent the second collar end and covering at least a portion the second axial face.

The at least one fastener may be a threaded fastener and may include a threaded shaft portion extending from the head portion and passing through the at least one collar fastener aperture and the at least one collar fastener aperture and a nut threadingly engaging the threaded shaft portion. The threaded shaft portion may extend axially beyond the nut providing an exposed anchor portion configured to be embedded within and axially restrained by the partition material surrounding the firestop apparatus.

The collar member may be of integral, one-piece construction.

The collar opening may have a first axial cross-sectional area, the sleeve opening may have a second axial cross-sectional area and the second axial cross-sectional area may be substantially the same as the first axial cross-sectional area.

The at least one fastener may have a greater thermal conductivity than the collar member. When the second collar end is exposed to elevated temperatures, heat is axially transferred from the second collar end toward the first collar end via at the at least one fastener more quickly than via adjacent portions of the collar member.

The second end of the sleeve member and the first end of the collar member may be substantially planar and may be disposed on opposite sides of a separation plane positioned axially between the sleeve member and the collar member.

The firestop apparatus may also include a gasket member having a gasket opening aligned with the sleeve opening and a laterally inner edge sized to sealingly contact the conduit member. The gasket member may include at least one gasket fastener aperture aligned with the at least one sleeve aperture and the at least one collar fastener aperture and the at least one fastener may pass through the at least one gasket fastener aperture. The gasket member may be positioned axially intermediate the second end of the sleeve member and the first collar end.

The collar member may also include at least one attachment member formed from the intumescent material. The at least one attachment member may be configured to receive an attachment fastener to couple the firestop apparatus to a form member for containing the partition material.

In accordance with another broad aspect of the teachings disclosed herein, which may be used in combination with any other aspect, a firestop apparatus for casting into a partition cast from a partition material may include a sleeve member. The sleeve member may extend along a sleeve axis and having a first end, a second end axially spaced apart from the first end and a sleeve sidewall extending between the first and second ends, the sleeve member having a sleeve opening extending between the first and second ends and may be configured to receive a conduit member. The sleeve member may include a laterally outer sleeve surface exposed to contact partition material surrounding the sleeve member. An intumescent collar member may be formed from an intumescent material. The collar member may have a first collar end adjacent the second end of the sleeve member, a second collar end axially spaced apart from the second collar end and a collar sidewall extending between the first and second collar ends. The collar member may have a collar opening to receive the conduit member. The collar opening may extend between the first and second collar ends and may be aligned with the sleeve opening. The collar member may include a laterally outer collar surface that is exposed to contact partition material cast around the sleeve member. The outer collar surface may be axially spaced apart from the exposed sleeve outer surface. The collar member may be expandable from a non-expanded configuration to an expanded configuration, in which the intumescent collar material expands at least laterally inwardly to seal against the conduit member, when exposed to temperatures above an expansion temperature of the intumescent material.

At least a portion of the laterally outer surface of the collar member may be positioned laterally outboard the laterally outer surface of the sleeve portion.

In accordance with another broad aspect of the teachings described herein, which may be used in combination with any other aspect, a firestop apparatus may include a sleeve member the sleeve member extending along a sleeve axis between a first end and a second end axially spaced apart from the first end. A sleeve sidewall may extend between the first and second ends and may laterally surround a sleeve opening extending between the first and second ends. The sleeve opening may be configured to receive a conduit member. An intumescent collar member may be positioned adjacent the second sleeve end and may extend axially between a first collar end and a second collar end. The collar member may be formed from an intumescent material that is expandable in at least the lateral and axial directions when exposed to temperatures above an expansion temperature of the intumescent material. The collar member may include a collar sidewall portion and a plurality of collar reservoir projections extending laterally outwardly from the collar sidewall portion and spaced apart from each other around a perimeter of the collar sidewall portion. The collar sidewall portion may extend between a first sidewall end face at the first collar end and a second sidewall end face at the second collar end and may laterally surrounding a collar opening, the collar opening aligned with the sleeve opening and configured to receive the conduit member, each collar reservoir projection extending axially between a second projection end face at the second collar end and a first projection end face spaced apart from the second projection end, a collar fastener aperture extending axially through each reservoir projection. A fastener may extend through each collar fastener aperture. Each fastener may include a securement portion securable to at least one of the sleeve member and the partition to prevent axial movement of the fastener relative to the collar member and a head portion covering at least a portion of the second projection end face to inhibit axial expansion of the intumescent material forming the reservoir projection.

The sleeve member may include a sleeve fastener aperture aligned with each collar fastener aperture and each fastener may extend through a respective sleeve fastener aperture to fasten the collar member to the sleeve member.

### DRAWINGS

The drawings included herewith are for illustrating various examples of articles, methods, and apparatuses of the teaching of the present specification and are not intended to limit the scope of what is taught in any way.

In the drawings:

FIG. 1 is a perspective view of an example of a firestop apparatus;

FIG. 2 is an exploded perspective view of the firestop apparatus of FIG. 1;

FIG. 3 is perspective view of a collar member from the firestop apparatus of FIG. 1;

FIG. 4 is a top view of the collar member of FIG. 3;

FIG. 5 is a cross-sectional view of the firestop apparatus of FIG. 1 within a partition;

FIG. 5a is an enlarged view of a portion of FIG. 5;

FIG. 6 is the cross-sectional view of FIG. 5 with a pipe extending through the firestop apparatus;

FIG. 7 is the cross-section view of FIG. 6 with the collar member in an expanded configuration;

FIG. 7a is the cross-section view of FIG. 7 with the pipe in a collapsed configuration;

FIG. 8 is a lower perspective view of the firestop apparatus of FIG. 1 with a pipe extending through the firestop apparatus;

FIG. 9 is a perspective view of the firestop apparatus of FIG. 1 in combination with an example of an extension member;

FIG. 10 is the perspective view of the FIG. 9 in combination with an example of a coupling member; and

FIG. 11 is a partially exploded view of FIG. 10.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

Commercial and residential buildings can have partitions, such as floors, walls and other dividing structures, which are fire rated for a specific period of time (for example 2 hours). In some buildings these partitions are formed from concrete and/or other generally fire-resistant materials. Service penetrations through these partitions are typically required to allow plumbing, electrical and other services to pass through the partitions. For example, pipes, wires, cables, air ducts, conduits and other items may need to pass through the wall or floor of a building. Such service penetrations breach the fire integrity of the partition and if untreated can reduce the fire resistance of the partition. To help maintain desired level of fire resistance, penetrations through the partitions may be provided with a suitable fire protection apparatus, such as a firestop apparatus described herein, that can provide a desired fire resistance. Optionally, the fire protection apparatus can be a passive apparatus (e.g. does not require electricity or other services to operate).

Fire tests that are conducted at accredited laboratories such as Underwriters Laboratories (UL) define a few different criteria; F (fire), T (temperature) and H (hose). The F-rating refers to the criteria that the firestop device seal the opening and maintain a seal for the rated time period (often 2 hours). The T-rating refers to the criteria that the hottest part of the device, on the unexposed side, stay below 325 F plus initial ambient temperature (in other words, stays below a temperature rise of 325 F) for the duration of the rating time (for example, 2 hours). The H-rating refers to the criteria that the firestop device to withstand the force of a 30 psi stream of water from a fire-hose for a short time period that is dependent on the rating period and area of the concrete slab used in the fire test.

Preferably, the fire protection or firestop apparatus can be configured to provide a fire rating, temperature rating and/or hose rating that is generally equal to or greater than the fire rating of the partition in which it is positioned. Alternatively, the ratings of the firestop apparatus may be different than the ratings of the partition.

Penetrations in fire-rated concrete partitions can be formed using a variety of known techniques. For example, after concrete is poured and set, holes can be cored through the concrete to provide an opening. Then either external firestop devices (such as firestop collars) or intumescent wrap strips (around the pipe within the cored hole) can be installed. This method may be employed for retro-fit applications (in which the partition is already created) and can also be employed for a newly constructed building. Alternatively, during the construction of the building, simple placeholder devices can be placed in the form and concrete can be poured around them. When the concrete has cured, the placehold can be removed, leaving a hole. In this case, the firestop device is added after the concrete has set. In yet another example, the firestop apparatus can be part of the concrete form device so that the concrete is poured, and sets, around the firestop apparatus.

Referring to FIG. 1, an example of a firestop apparatus 100 suitable for being cast-in a concrete partition includes a sleeve member 102, a collar member 104 coupled to one end of the sleeve member 102 and a cap member 106 covering the other end of the sleeve member 102. Together, the sleeve member 102 and collar member 104 are configured to receive one or more suitable conduit members, including for example pipes, wires, cables, air ducts and electrical wires. In the illustrated example, the conduit member is provided in the form of pipe 108 (see FIG. 6). In the illustrated example, a generally annular gap 110 is formed between the outer surface 112 of the pipe and the inner surfaces 114 and 116 of the sleeve member 102 and collar member 104, respectively.

Referring to FIG. 7, the collar member 104 is formed from an intumescent material which expands when exposed to elevated temperatures above its activation temperature. The collar 104 is generally configured to surround the pipe 108 passing through the firestop apparatus 100, and when heated, to expand from a non-expanded configuration (FIG. 6) to an expanded configuration (FIG. 7). In the illustrated example, the intumescent collar 104 is expandable laterally inwardly toward the pipe 108 to press against the outer surface 112 of the pipe 108 to seal the annular gap 110 (FIG. 7).

Alternatively, referring to FIG. 7a, in some embodiments the pipe 108 may be weakened or destroyed by the fire (for example if the pipe 108 is formed from ABS or PVC plastic). In such embodiments the intumescent collar 104 may be expandable to fill substantially all of the opening in the partition 120 (e.g. the substantially the entire diameter 150 of the sleeve member 102). In this embodiment the expansion of the intumescent collar 104 may be sufficient to collapse the pipe 108 (as illustrated). Optionally, the intumescent material in collar 104 may expand sufficiently to fill the entire diameter 150 if the pipe 108 is not present, or if the pipe 108 is destroyed, so that the intumescent may form a complete plug in the partition 120 (e.g. substantially block the passage through the firestop apparatus 100).

Sealing the annular gap 110 may help limit the passage of heat, flames and hot combustion gases through the firestop apparatus 100, from one side of the partition 120 to the other. Limiting the transfer of heat, flames and combustion gases through the partition 120 may help prevent fire on one side of the partition 120 from spreading to the other side of the partition 120.

Optionally, the intumescent material can be configured so that it also expands axially (i.e. in the direction of axis 118) when exposed to elevated temperatures. In the illustrated example, the collar member 104 is formed from intumescent material that expands axially as well as radially. In this configuration, when the intumescent collar 104 is expanded the intumescent material extends axially upwards (as illustrated) into the annular gap 110 and downwards. Portions of the collar 104 expanding downward may cover more of the outer surface 112 of the pipe 108, and may also expand radially outwardly to cover portions of the bottom surface of the partition 120. Expanding in this manner may increase the axial height of the intumescent material such that an expanded height 160a (FIG. 7) is greater than the non-expanded height 160 (FIG. 5). Increasing the axial height 160a of the intumescent material forming the collar 104 may help increase the thermal insulating properties, or T-rating of the collar member 104, by increasing the amount of material positioned between the tire (below the partition 120) and other areas of the building (above the partition). Increasing the thermal insulation of the firestop apparatus 100, as well as sealing the annular gap 110 to prevent fluid flow therethrough, may help improve the overall fire rating of the firestop apparatus 100, and may help further retard the spread of a fire through the partition 120 (as opposed to providing only fluid sealing via radial-only expansion).

To help enable the collar 104 to seal against the pipe 108 during a fire, the collar member 104 includes at least some intumescent material that expands when exposed to temperatures above an expansion temperature. When selected for use in commercial or residential buildings, the intumescent material may be configured to have an expansion or activation temperature that is between about 200 and about 500 degrees Fahrenheit, and may be between about 300 and about 325 degrees Fahrenheit. Accordingly the intumescent material will expand when exposed to temperatures created by normal residential or commercial building fires, which can reach temperatures of about 1800-2000 degrees Fahrenheit.

Optionally, the collar member 104 may be formed substantially entirely from intumescent material. In this configuration, the intumescent material is selected to have mechanical properties that are suitable so that the collar member 104 can form a structural component of the firestop apparatus 100. Preferably, the intumescent material used to form the collar member is strong enough to maintain its shape during the assembly and casting processes, and can retain fasteners and bear other structural-type loads. For example, the collar member 104 can support the sleeve 102 and can be connected to the sleeve 102 using mechanical fasteners, such as bolts 130, preferably without crushing or deforming the collar member 104.

In the illustrated example the intumescent material is in direct contact with the concrete or other material forming the partition 120, and may be selected so that it can be in contact with the concrete, in both a liquid and solid or cured state, without being damaged, rendered inoperable or otherwise rendered ineffective for its purpose of expanding to seal against the pipe 108. For example, the intumescent material used may be generally liquid impermeable and may be non-reactive with water, concrete and other building materials.

In the illustrated example, the firestop apparatus 100 is configured for use within a generally horizontally oriented concrete floor 120, and is illustrated in a generally vertical orientation. For clarity, terms like top, bottom, upper and lower may be used to describe portions of the firestop apparatus 100 and its position within the partition, but are not intended to limit the orientation or configuration of the firestop apparatus 100. For example, the firestop apparatus 100 may also be installed within upright partitions, such as walls, or any other suitable location in which case terms like first, second, left, right, front and back may be substituted for the directional terms used herein.

When assembled as illustrated, the firestop apparatus 100 is placed within a partition form, for example within a wooden form (a portion of which is illustrated as form 122 in FIG. 5) or on top of a corrugated metal form, prior to pouring the concrete (or any other suitable material that may be used to construct a fire-rated partition) into the form. The liquid concrete is then poured into the form and allowed to set or cure around the firestop apparatus, thereby encasing the firestop apparatus within the partition. The outer, exposed surfaces of the firestop apparatus 100 may serve as part of the form. When the concrete cures the firestop apparatus 100 will be encased within the partition. In the illustrated example, outer surface 124 of the sleeve 102 and the outer surface 126 of the collar 104 are exposed and are in contact with the concrete partition 120.

Optionally, the firestop apparatus 100 may include one or more anchor or securement portions 128 (FIG. 5) that can be encased in the concrete and may prevent the firestop apparatus 100 from being removed from the partition 120 after it solidifies. In this configuration, the firestop apparatus 100 may not be removable from the partition after the liquid concrete has solidified.

Referring to FIG. 2, the sleeve member 102 includes a coupling portion 132 and at least one sidewall 134 extending from the coupling portion 132 along a sleeve axis 136. In the illustrated example the sleeve member 102 is configured as a generally tube-like member and has a generally round cross-sectional shape to receive the round pipe 108. In this configuration the sidewall 134 extends between a first or upper sleeve end 138 and a second or lower sleeve end 140. In the illustrated example, the coupling portion 132 is provided at the lower end 140 of the sleeve member 102, and the upper end 138 of the sidewall terminates in an upper edge or rim 142. Referring to FIG. 5, the axial distance between the lower end 140 and upper end 138 of the sleeve member 102 defines a sleeve height 144. The sleeve height 144 may be any suitable height that can fit within a partition having a given thickness 146, and may be between about 2 cm and about 50 cm, and preferably is between about 10 cm and about 25 cm.

The sidewall 134 also surrounds and defines an internal sleeve aperture 148 or passageway that is configured to receive the pipe 108. In the illustrated example, the sleeve aperture 148 is a generally cylindrical passage that extends axially through the entire sleeve member, between the lower and upper ends 140, 138, and has a diameter 150. The diameter is sized to be able to slidably receive the pipe 108, and optionally one or more additional service conduits or cables, and is at least equal to or greater than the outer pipe diameter 152 (FIG. 6). In the illustrated example, the sleeve diameter 150 is greater than the pipe diameter 152, and may be between about 5 cm and about 25 cm, and preferably is between about 8 cm and about 15 cm. Optionally, the firestop apparatus 100 may be configured to have a sleeve diameter 150 that is less than 5 cm or greater than 25 cm if necessary or desired to accommodate a particular conduit, cable or combination of service members.

The sleeve member 102 can be formed using any suitable process and from any suitable material, including for example, metal, plastic and composite materials. In the illustrated example, the sleeve member 102 is injection molded as a unitary, one-piece member and is formed from thermoset plastic. Thermoset plastic may be a desirable material because it is relatively low cost (as compared to metals, etc.) and is relatively easy to manufacture. It may also be desirable because it can withstand temperatures in the range of 300-400 degrees Fahrenheit without melting or otherwise losing its structural integrity. In the illustrated configuration, the sleeve member 102 may be insulated from the high temperature of the fire by the intumescent material in the collar 104. Alternatively, the sleeve member may be made from another suitable material.

Referring to FIG. 1, in the illustrated example the collar member 104 is positioned outside and below the sleeve member 102, and is coupled to the lower end 140 of the sleeve member 102. Referring to FIG. 3, the collar member 104 includes a base portion 154 that has a generally annular sidewall 156 that extends along and defines a collar axis 158 (FIG. 5) and provides the inner surface 116 (FIG. 4). In the illustrated example, the collar axis 158 is parallel to the sleeve axis 136.

Referring to FIG. 5, the collar member 104 has a height 160 in the axial direction. The height 160 can be any suitable height, and may be between about 0.5 cm and about 10 cm or more, and between about 1.5 cm and 4 cm. Optionally, the collar height 160 may be between about 10% and about 65% of the sleeve height 144, and optionally may be between about 25% and 45% of the sleeve height 144. The height 160 can be selected so that the combination of heights 160 and 144 is equal to or less than the height 146 of the partition 120.

In the illustrated example, the sidewall 156 includes the inner surface 116 and surrounds a collar aperture 166. The base portion 154 also includes an opposed, laterally outwardly facing base portion outer surface 168 (FIG. 4). Optionally, the base portion 154 of the collar member can have a generally uniform lateral thickness 170, and may be generally ring-like in configuration. The thickness 170 of the base portion may be between about 0.5 cm and about 4 cm or more, about 1 cm and about 2 cm, and in the example illustrated is about 0.7 cm. The thickness 170 of the base portion 154 may be selected based on the size of the collar member 104, the size of the annual gap 110, and/or the diameter 150 of the sleeve member 102 to be sealed during a fire.

Referring to FIG. 5, the collar aperture 166 is an axially extending through-hole providing a passageway through the collar member 104. To help provide a continuous axial passageway through the firestop apparatus 100, the collar aperture 166 is registered with the sleeve aperture 148. In this example, the collar axis 158 is co-axial with the sleeve axis 136.

The collar aperture 166 has a diameter 172 that is sized to receive the pipe 108. Preferably, the diameter 172 is generally equal to the diameter 150 of the sleeve aperture 148 to provide a passage of generally constant size. Alternatively, the collar aperture diameter 172 may be greater than or smaller than the sleeve diameter 150.

In the illustrated example, the intumescent material forming the collar member 104 is all positioned below a plane 162 that contains the lower end 140 of the sleeve member 102, and when the collar 104 is in its unexpanded configuration (FIG. 5) no intumescent material is positioned within the sleeve aperture 148, or extends upwardly around the outer surface 124 of the sleeve sidewall 134. Providing generally flat, planar surfaces at the connection between the collar member 104 and the sleeve member 102 may help simplify assembly of the firestop apparatus 100, and may help simplify the molding of the collar 104 and sleeve members 102. Alternatively, portions of the collar 104 may be configured to extend above the plane 162, and/or portions of the sleeve member 102 may project downwardly below the plane 162.

Referring to FIG. 2, the collar member 104 has an inner collar end 174 that is coupled to the bottom 140 of the sleeve member 102, and an outer collar end 176 that is axially spaced apart from the inner collar end 176. In the illustrated example, the inner collar end 174 has a generally planar inner end face 178 which, in the illustrated embodiment includes the inner face 157 of the base portion 154 and the inner end faces 194 of the reservoir portions 182 (see FIGS. 3 and 4). Alternatively, as explained herein, the end faces 194 of the reservoir portions 182 may be axially spaced apart from the inner face 157 of the base portion 154, and may not form part of the inner end face 178.

In the illustrated configuration, the inner end face 178 lies in the plane 162, and opposes the lower end face of the sleeve member 102. The outer end 176 of the collar 104 also includes a planar outer end face 180 (FIG. 6) that is parallel to, and spaced apart from the inner end face 178. In the illustrated embodiment the outer end face 180 lies in the same plane 190 as the outer surface of the partition 120. Providing a planar outer end face 180 may help the outer end 176 of the collar 104 to be positioned flush with the bottom surface of the partition 120.

Optionally, in addition to a generally ring-like base portion 154, the collar member 104 can include one or more projections extending laterally outwardly from the outer surface 168 of the base side wall 156. Preferably, the projections are formed from the same intumescent material as the base portion. The projections can be spaced apart from each other around the perimeter of the base portion, and optionally can be equally spaced from each other. Optionally, the thickness of the base wall can be the same, or greater than, the lateral thickness of the sleeve sidewall, so that substantially all of each projection is positioned laterally outside of the collar and sleeve apertures, and outboard the sidewall of the sleeve member.

Referring to FIG. 3, in the illustrated example the collar member 104 includes a plurality of projections in the form of reservoir portions 182 formed from the intumescent material and extending laterally outwardly from outer base surface 168. The reservoir portions 182 are spaced apart from each other around the perimeter of the base portion 154. In this configuration, the perimeter of the collar member 104 (measured in a first horizontal plane passing through the collar member 104) is greater than the perimeter of the sleeve sidewall 134.

In the illustrated example, the axial height 184 of each reservoir portion 182 is generally equal to the height 160 of the sidewall 156. In this configuration, the collar member 104 has a generally constant collar height. Alternatively, the reservoir portions 182 may be a different height than the sidewall 156.

The reservoir members may be of any suitable cross-sectional shape. In the illustrated example, the reservoir portions 182 include a root 186 (FIG. 4) that is generally rectangular and a generally rounded tip 188 spaced radially outboard of the root 186.

In the illustrated example, each reservoir portion 182 includes an inner end 192 having an inner end face 194, and an outer end 196 having an outer end face 198. In the illustrated example, the inner end faces 194, 157 of the reservoir portions 182 and the base portion 154 respectively, are co-planar and co-operate to provide the inner end face 178 of the collar member 104. When assembled as shown, substantially all of the inner end face 178 of the collar member 104 is covered by a downward facing lower surface of the coupling portion 132 of the sleeve member 102.

Preferably, the entire collar member 104, including the base portion 154 and reservoir portions 182, can be of integral, one-piece construction, and optionally can have a generally homogeneous composition. One example of an intumescent material that is suitable for forming a one-piece, homogenous intumescent collar member includes a plurality of intumescent particles suspended within a plastic, preferably thermoplastic, material.

The intumescent particles can be formed from any suitable intumescent material, including known materials that are only expandable in a single direction, such as expandable graphite. Orienting the individual particles of intumescent material in different orientations within the thermoplastic material enables the material to be expandable in at least the primary and secondary directions, even if each intumescent particle is only expandable in a single direction. Encapsulating relatively small intumescent particles within a thermoplastic matrix can insulate the intumescent particles from the surrounding atmosphere, which may help inhibit degradation of the intumescent material. The thermoplastic can be selected to exhibit relatively little creep at room temperature (for example when compared to Palusol™), which can provide an intumescent layer that is generally resistant to creep at room temperature, even if the intumescent material used to form the particles has a high creep susceptibility. The thermoplastic material can be selected to have a melting temperature that is lower than an activation temperature of the intumescent particles, so the plastic can be melted without activating the expansion of the intumescent particles. This enables the mixture of intumescent particles and thermoplastic material to be extruded and/or injection molded to form the collar member, and may allow the thermoplastic material to melt and flow prior to and during the activation of the intumescent particles.

In the illustrated example, because the intumescent particles are generally randomly positioned and oriented within the thermoplastic material, the collar member can expand in multiple directions (for example laterally inward toward the pipe, and downward, away from the sleeve member) even if the intumescent particles themselves are only expandable in a single direction. Optionally, the expansion of the collar member 104 in any given direction can be restrained by providing covers, retainers or other barriers that can impede the expansion of the intumescent material. For example, these retainers may be configured to help direct the expansion of the collar inwardly (toward the pipe 108) and downwardly, and to limit the expansion of the collar 104 laterally outwardly (away from the pipe). The retainers and barriers may be formed as part of the firestop apparatus 100, and/or may be provided as separate members positioned around the firestop apparatus 100. In the illustrated example, in which portions of the collar member 104 are directly exposed to and encased within the concrete material, the cured concrete itself may provide a barrier to radially outward and/or upward expansion of the collar member 104.

If formed from the thermoplastic based intumescent material described herein, or suitable alternative, the material from the reservoir portions 182 can soften when heated by a fire, and can be guided to flow inwardly before and/or while it is expanding. In this configuration, the material forming the reservoir portions 182 can flow toward or into the annular gap 110 and/or the complete sleeve opening having diameter 150, and provide extra intumescent material (in addition to the material of the base portion 154) to help seal the gap 110. Storing at least some of the intumescent material outside the diameter 150 of the sleeve aperture 148 may enable the firestop apparatus 100 to provide a relatively large passageway, while still having sufficient intumescent material that can be injected into or flow into the collar aperture 166 to seal the annular gap 110 (for example if a metal pipe 108 is used) and/or the complete sleeve aperture 148 (for example if the pipe 108 is plastic) when heated.

Optionally, the combined volume of the reservoir portions 182 may be between about 30% and about 70% of the total volume of the collar member 104, and may be between about 40% and 60% and about 50% of the total volume.

In the illustrated example, the coupling portion 132 of the sleeve 102 is configured to cover substantially all of the inner end face 178 of the collar 104. Referring to FIG. 2, in the illustrated example, the coupling portion 132 includes the bottom rim 202 of the sleeve sidewall 134 and a plurality of laterally extending flanges 200 that extend outwardly from the sidewall 134. Each flange 200 is shaped and sized to overlie the inner end face 194 of a respective reservoir portion 182, and when the flanges 200 are covered with cured concrete they may help limit upward, axial expansion of the underlying reservoir portion 182.

While illustrated as including six flanges 200 (one per reservoir portion 182), the sleeve member 102 may include any suitable number of flanges, including for example between 1 and 10 flanges, or more than 10 flanges, and preferably includes at least two flanges. Optionally, the sleeve member 102 may include fewer flanges 200 than reservoir portions 182, and at least one reservoir portion may remain uncovered when the firestop apparatus 100 is assembled.

In the illustrated example the flanges 200 have an arcuate outer edge, which generally matches the curvature of the curved tips 188 of the reservoir portions 182. Alternatively, the flanges 200 may be of any suitable shape and size, and need not match the shape of the collar member. Optionally, the number of flanges may be different than the number of reservoir portions on the collar member.

In the illustrated example, the sleeve member 102 is of integral, one-piece construction. Providing the sleeve member 102 as a single, integral piece may help simplify the manufacturing of the sleeve member, and may help simplify assembly of the firestop apparatus 100. Providing a unitary sleeve member 102 may also reduce the number of seams or joints in the sleeve member 102. This may help reduce the likelihood of moisture or liquid leaking into the sleeve member 102 during the partition 120 casting process. Alternatively, the sleeve member 102 may be formed from two or more separate pieces.

Referring to FIG. 5, the lateral outer surface 126 of the collar member 104, which in the example illustrated includes both the outer surfaces 210 of the reservoir portions 182 and the exposed portions of the outer surface 168 of the base portion 154, is not surrounded by a housing or any portion of the sleeve member 102. In the illustrated example, the lateral outer surface 126 is exposed to the concrete (or other material) forming the partition 120. As the concrete solidifies around the firestop apparatus 100, a cavity 206 is formed in the partition 120, around the reservoir portions 182, and other components. Referring to FIG. 5a, the cavity 206 includes a radially inwardly facing surface 208 that opposes and engages the lateral outer surface 126 of the collar member 104. In the illustrated example, the surface 208 opposes and engages the lateral outer surface 210 of the reservoir portions 182 and, at locations between reservoir portions 182, the outer surface 168 of the base portion 154. In this configuration, the surfaces of the concrete material may form barriers or retaining members that limit laterally outward expansion of the collar member 104 when heated, and help direct the expansion of the intumescent material inwardly toward the pipe 108. For example, when the collar member 104 is heated, the intumescent material may begin to expand in the radial direction and may act against the inner surface 208 of the cavity 206. A reaction force between the intumescent material and the surface 208 can urge the intumescent material inwardly (toward gap 110) and may cause the material in the reservoir portions 182 to flow inwardly as it is heated.

Optionally, the sleeve member 102 may be coupled to the collar member 104 using any suitable connection mechanism. Referring to FIG. 2, in the illustrated example, the sleeve member 102 is coupled to the collar member 104 using fasteners 212. Optionally, the fasteners 212 can be configured to connect the sleeve member 102 to the collar member 104 and to anchor the collar member 104 directly to the partition 120. Optionally, if the fasteners 212 are configured to anchor the collar member 104 within the partition 120 they can include at least one anchor portion, that can be encased within and retained in the liquid concrete that is poured around the firestop apparatus 100, and a retaining portion for engaging the collar member 104. Optionally, the retaining portion can be configured to help limit axial (downward as illustrated) expansion of the collar member 104 and to direct the expansion of at least some of the intumescent collar member upward. Providing the anchor portion and retaining portion on the fasteners 212 may help reduce the number of components and/or the overall size of the firestop apparatus 100. It may also allow the fasteners 212 to carry a substantial portion of the axial force expansion force exerted by the collar member 104 as it expands, and to transfer most of that force directly to the partition 120, instead of exerting downward axial expansion forces on the sleeve member 102. In this configuration, the sleeve member 102 need not be configured to withstand significant, downward axial loads.

Referring to FIG. 2, in the illustrated example each fastener 212 includes a bolt having a head 214, a threaded region 216 and a shank or connecting portion 218 extending therebetween. The fasteners 212 also include corresponding nuts 220 that can be threaded onto the threaded region 216. In the illustrated example, the fasteners 212 pass through corresponding fastener apertures 222 and 224 (which extend generally axially in the reservoir portions 182 and the flanges 200, respectively, and are positioned laterally outboard of the sleeve member sidewall 134 and the base portion 154 of the collar member 104).

Referring also to FIG. 5a, in the illustrated example the head 214 forms the retaining portion of the fastener 212 and inhibits axial expansion of any underlying or covered portions of the collar member 104, and the threaded region 216 functions as an anchor portion securing the collar 104 to the partition 120, as explained in more detail herein.

Optionally, the bolt head 214 can be a relatively thin, wide disc-like member. Providing a thin bolt head 214 may help reduce the overall height of the firestop apparatus. Further, the bolt head 214 can be recessed into the collar member 104 so that the outer surface 226 of the bolt head 214 is generally flush with the outer end face 180 of the collar member 104, and lies in plane 190. This may help provide a generally planar collar lower end face. Preferably, the thickness 228 of the bolt head 214 is between about 0.1 cm and about 0.3 cm, or more.

In the illustrated example, each bolt head 214 has a diameter 230 (FIG. 8) that is generally equal to the diameter 232 (FIG. 2) of the tip portion of the underlying reservoir portion 182. The bolt head 214 can sized to cover between about 30% and about 90% or more of the outer end face 198 of the reservoir portion 182. Providing the bolt head 214 in this position may help constrain downward axial expansion of the regions of each reservoir portion 182 that are covered by a corresponding bolt head 214. As the reservoir portions 182 are laterally surrounded by concrete partition 120 and have inner end faces 194 covered by the flanges 200 of the sleeve member 102 (which are covered in cured concrete), covering the outer end faces 198 of the reservoir portions 182 with the bolt heads 214 may leave only the laterally inward facing sides of the reservoir portions 182 unblocked/uncovered. This may help direct substantially all of the expansion intumescent material in the reservoir portions 182 inwardly, to help seal the annular gap 110 and/or the entire sleeve aperture 148.

Optionally, the remaining portions of the outer end face 180 of the collar member 104, including, for example the lower edge of the sidewall 156, may remain uncovered. Leaving at least a portion of the outer collar end face 180 uncovered may allow some expansion of the collar member 104 downward, toward the fire. Providing at least some secondary expansion in the axial direction may help increase the height of the expanded intumescent material in the axial direction, which may help reduce heat transfer in the axial direction.

To help transmit expansion force directly to the partition 120, the fasteners 212 include anchor portions that are embedded in/encapsulated within the partition 120. The anchor portion may be of any configuration that is can be retained within the solidified concrete of the partition. In the illustrated example, the anchor portion is provided in the form of an exposed portion of the threaded region 216.

In this configuration the threaded region 216 can perform two functions. When assembling the firestop apparatus 100, providing a threaded region 216 on the bolt allows the nut 220 to be threaded onto the bolt to fasten the sleeve member 102 to the collar member 104. In the illustrated embodiment the fasteners 212 provide the only connection between the sleeve 102 and the collar member 104.

In addition, in the illustrated example, the threaded region 216 has an exposed length 234 (FIG. 5a) that is extends beyond the nut 220, so that at least some threads remain exposed after the nut 220 is tightened, thereby providing the anchor portion of the fastener 212. Optionally, the fastener apertures 224 are sized so that the threaded portion 216 and connection portion 218 (if applicable) are freely receive within the apertures 224, and do not directly threadingly engage the sleeve member 102. This may help reduce the force transfer between the fasteners 212 and the sleeve member 102.

When the firestop apparatus 100 is positioned within the partition form, liquid concrete flowing around the firestop apparatus 100 can surround the exposed threads forming the anchor portion. When the concrete hardens, the threads are fixed within the concrete, thereby anchoring the bolts, and the collar member 104 within the partition. The length 234 of the threaded region 216 that remains exposed to serve as the anchor portion may be selected based on the desired anchor strength, coarseness of the thread, consistency of the concrete and other factors, and may be between about 0.5 cm and about 2 cm or more. Alternatively, instead of a portion of the threaded region 216, the anchor portion of the fastener 212 may be of any other suitable configuration and optionally may be provided as a feature on the bolt (e.g. a radial hole, flange, flared portion, etc.), as a structure on the nut 220 (e.g. a flange or collar, coarse surface features, etc.) or as a separate member.

Referring to FIG. 5, each fastener 212 defines a respective fastener axis 236. In the illustrated example, the fastener axes 236 are generally parallel to each other and to the collar and sleeve axes 158, 136, and are laterally offset from the sleeve axis 136. In this configuration the fastener axes 236 are positioned laterally outboard of the base portion 154 and the sleeve member 102.

The connecting portion 218 of each bolt is positioned within and extends freely within its aperture 222 in its respective reservoir portion 182. That is, the connecting portion 218 does not threadingly engage, or otherwise directly engage, the collar member 104. In the illustrated example, expansion forces exerted on the heads 214 of the bolts can be transferred directly to the partition 120 via the connecting portion 218 and threaded region 216, and need not be carried by portions of the collar member 104 and/or the sleeve member 102.

When the firestop apparatus 100 installed within the partition, portions of the fasteners and collar member 104, for example the exposed surface 226 of the heads 214 and exposed portions of the outer end face 180, may be exposed to a fire below the partition. Optionally, the collar member 104 can include one or more thermal conducting members that extend through the collar member 104 to help distribute heat within the collar member 104. The thermal conducting member can be formed from a material that has a relatively high thermal conductivity, relative to the intumescent material forming the collar member 104, such as metal. For example, the thermal conducting members can be formed from a material having a thermal conductivity that is between about between about 13 and about 450 W/(m.K) at 25 deg. C.

Optionally, to help achieve a desired T-rating some secondary (axial) expansion of the intumescent collar 104 is desired to slow the temperature propagation rate through the firestop apparatus 100. Preferably, the thermal conductors can help provide good heat transfer to the intumescent collar 104 to trigger its expansion and to seal the gap 110 and/or sleeve aperture 148 quickly, but then the axial expansion will increase the height 160a of the intumescent material, which may help achieve a desired, slow heat transfer rate through the firestop device from hot side of the partition 120 to the cooler, unexposed side of the partition.

In the illustrated embodiment, the fasteners 212 are formed from metal, and can also function as thermal conducting members. Providing thermally conductive fasteners 212 may help transfer and/or distribute heat through the interiors of the reservoir portions 182 when the heads 214 of the bolts are heated. This may help trigger relatively early and/or uniform expansion of the reservoir portions 182, including portions that are axially spaced apart from the heat source. Quickly triggering expansion along the length of the reservoir portions 182, and optionally along with other portions of the collar member 104, may enable the collar member 104 to seal the annular gap 110 and/or sleeve aperture 148 quickly, thereby helping to limit the spread of the fire. To help distribute heat within the collar member 104, preferably at least the heads and connecting portions of the fasteners 212 are formed from thermally conductive material. Optionally, the anchor portion may also be formed from thermally conductive material.

In addition to, or as an alternative to providing thermally conductive fasteners 212, one or more axially extending thermal conductors can be positioned within the reservoir portions and/or base portion of the collar member. For example, metal rods or other suitable members can be positioned within the collar member to help transfer heat into the intumescent material.

In the illustrated example, the fasteners 212 are used to anchor the collar member 104 relative to the partition, and are also used to secure the sleeve member to the collar member. Alternatively, or in addition to connection via the anchor fasteners, the sleeve member 102 may be connected to the collar member using one or more fasteners that are independent from the fasteners 212. Optionally, instead of or in addition to mechanical fasteners, the sleeve member 102 may be coupled to the collar member 104 using a chemical adhesive or any other suitable mechanism.

To help keep the firestop apparatus 100 in its desired location during the concrete pouring process, the firestop apparatus 100 can be secured to the form using any suitable securement apparatus. Optionally, the securement apparatus can include one or more attachment members configured to receive a fastener. Referring to FIG. 1, in the collar member 104 includes a plurality of laterally extending attachment members in the form of mounting tabs 238. Preferably, the mounting tabs 238 are positioned toward the bottom of the collar member 104 so that they are generally adjacent the form 122 upon which the firestop apparatus 100 (FIG. 5) is seated. Each mounting tab 238 includes a respective hole 240 to receive a mounting fastener, such as a nail 242 or a screw, that can be used to secure the firestop apparatus 100 to the form 122.

In the illustrated example, the mounting tabs 238 are integrally formed with the reservoir portions 182 and base portion 154, and are formed from the thermoplastic-based intumescent material. Providing mounting tabs 238 formed from the same intumescent material may simplify manufacturing of the collar member 104. In this configuration, the intumescent material selected should have sufficient mechanical strength and other properties to support the nails 242 and to hold the firestop apparatus in position without failing when the form is filled liquid concrete.

Referring to FIG. 1, to help prevent liquid concrete from flowing into the interior of the firestop apparatus 100 when the concrete is poured, the cap 106 can seal the rim 142 of the sleeve 102. The cap 106 includes a sidewall 244 and an end wall 246 member. The sidewall 244 of the cap 106 can be fastened to the upper rim 142 using any suitable mechanism, including, for example a snap or press fit, a threaded connection and mechanical or chemical fasteners. The end wall 246 covers the sleeve aperture 148. When the partition 120 is cured, the end wall 246 can be removed and/or destroyed to provide access to the sleeve aperture 148 (FIG. 6), and the sidewall 244 may form part of the passage through which the pipe 108 passes.

Optionally, the firestop apparatus 100 may include one or more sealing or gasketing members 248 to inhibit air flow through the annular gap 110 (FIG. 2). Such gaskets may help reduce air flow through the annular gap 110 during normal (e.g. non-fire conditions) and during the early stages of a fire, for example when a fire has started but is not yet hot enough or close enough to the firestop apparatus 100 to trigger the intumescent collar 104. This may help reduce the transfer of smoke, etc. within the building. Any suitable gasket member can be used.

Referring to FIG. 2, in the illustrated example a flexible, resilient gasket member 248 is provided between the sleeve member 102 and the collar member 104. The gasket 248 includes a central hole 250 that is sized to snugly receive the pipe 108, and to seal against its outer surface 112. The gasket 248 also includes a plurality of fastener apertures 252 to accommodate the fasteners 212. Positioning the gasket 248 between the end faces of the collar member 104 and the sleeve member 102 may help protect the gasket member during the concrete pouring process. In this configuration, the gasket 248 may be held in place by the 212 fasteners, friction/compression forces exerted by the end faces, another suitable fastener such as adhesive, or a combination thereof. The gasket 248 can be formed from any suitable material.

Optionally, one or more extension members can be used to increase the length of the firestop apparatus 100, for example for use within thicker partitions. Optionally, the extension member may be another sleeve member, or a slightly modified sleeve member. This may allow common parts to be used to provide firestop apparatuses of varying heights. Referring to FIG. 9, and example of an extension member 1102 is a modified sleeve member 102, and analogous features are identified using like reference characters indexed by 1000. In this example, the extension member 1102 includes a sidewall 1134, a first end 1140 that can be coupled to the upper rim 142 of the sleeve member 102, and a second end 1138 that can be coupled to the cap 106. Optionally, the extension member 1102 need not include a coupling portion for connecting to the collar member 104, but could be provided with a coupling portion so that the extension member 1102 is interchangeable with the sleeve member 102.

While illustrated as being mounted to a generally flat form 122 (FIG. 5), the firestop apparatus 100 may also be mounted to different forms, including, for example, corrugated steel forms. If the form is configured such that it does not include flat surfaces sufficient to accommodate the firestop apparatus 100, a coupling member may be used. The coupling member may be any suitable member that includes a surface upon which the firestop apparatus 100 can be mounted, and optionally may include an extension tube that extends through the extent of the corrugated form (as required). Referring to FIG. 10, an example of a coupling member 260 includes a planar support surface 262 and an extension tube 264 depending therefrom. The tube 264 is sized to receive the pipe 108, and may have a diameter that is generally equal to or greater than the collar diameter 172. The firestop apparatus 100 may be attached to the support surface 262 using any suitable means, including, for example fasteners that pass through the mounting tabs 238, and by passing the fasteners 212 through apertures 266 in the support surface 262.

What has been described above has been intended to be illustrative of the invention and non-limiting and it will be understood by persons skilled in the art that other variants and modifications may be made without departing from the scope of the invention as defined in the claims appended hereto.

1. A firestop apparatus configured to be cast within a partition cast from a partition material, the firestop apparatus comprising:
a) a sleeve member, the sleeve member extending along a sleeve axis and having a first end, a second end axially spaced apart from the first end and a sleeve sidewall extending between the first and second ends, the sleeve member having a sleeve opening extending between the first and second ends and configured to receive a conduit member, the second end of the sleeve member comprising a sleeve member coupling portion having at least one sleeve fastener aperture;
b) an intumescent collar member adjacent the second end of the sleeve member, the collar member having a first collar end abutting the second end of the sleeve member, a second collar end axially spaced apart from the second collar end and a collar sidewall extending between the first and second collar ends, the collar member having a collar opening to receive the conduit member, the collar opening extending between the first and second collar ends, being bounded by a laterally inwardly facing collar inner surface and being aligned with the sleeve opening, the collar member formed from an intumescent material comprising a plurality of intumescent particles within a thermoplastic material and being expandable from a non-expanded configuration to an expanded configuration, in which the intumescent collar material expands at least laterally inwardly to seal against the conduit member, when exposed to temperatures above an expansion temperature, and the collar member comprising at least one collar fastener aperture aligned with the at least one sleeve fastener aperture; and
c) at least one fastener extending through the at least one sleeve fastener aperture and the at least one collar fastener aperture and fastening the collar member to the sleeve member.

2. The firestop apparatus of claim 1, wherein the at least one fastener extends along a fastener axis and the fastener axis is substantially parallel to and laterally spaced apart from the sleeve axis.

3. The firestop apparatus of claim 1, wherein the at least one fastener is laterally outboard of the sleeve sidewall.

4. The firestop apparatus of claim 1, wherein the collar member further comprises a plurality of reservoir projections extending laterally outwardly from the collar sidewall and spaced apart from each other around the perimeter of the collar sidewall, each reservoir projection extending axially from the second collar end to a first reservoir projection end face positioned axially between the second collar end and the second sleeve end, and one of the plurality of reservoir projections comprises the at least one collar fastener aperture.

5. The firestop apparatus of claim 4, wherein the coupling portion of the sleeve member comprises a plurality of flanges extending generally laterally outwardly from the sleeve sidewall, each flange covering a portion of the first collar end and one flange comprises the at least one sleeve fastener aperture.

6. The firestop apparatus of claim 4, wherein the combined volume of the reservoir projections is between about 40% and about 60% of a total volume of the collar member.

7. The firestop apparatus of claim 1, wherein at least a portion of a laterally outer surface of the collar member is exposed to contact the partition material.

8. The firestop apparatus of claim 1, wherein the sleeve sidewall comprises a laterally outer surface to contact the partition material and at least one portion of the collar member is disposed laterally outboard of the laterally outer surface of the sleeve sidewall.

9. The firestop apparatus of claim 1, wherein the second collar end comprises a second axial face and the at least one fastener comprises a head portion positioned adjacent the second collar end and covering at least a portion the second axial face.

10. The firestop apparatus of claim 9, wherein the at least one fastener is a threaded fastener and includes a threaded shaft portion extending from the head portion and passing through the at least one collar fastener aperture and the at least one collar fastener aperture and a nut threadingly engaging the threaded shaft portion, the threaded shaft portion extends axially beyond the nut providing an exposed anchor portion configured to be embedded within and axially restrained by the partition material surrounding the firestop apparatus.

11. The firestop apparatus of claim 1, wherein the collar member is of integral, one-piece construction.

12. The firestop apparatus of claim 1, wherein the collar opening has a first axial cross-sectional area, the sleeve opening has a second axial cross-sectional area and the second axial cross-sectional area is substantially the same as the first axial cross-sectional area.

13. The firestop apparatus of claim 1, wherein the at least one fastener has a greater thermal conductivity than the collar member, whereby when the second collar end is exposed to elevated temperatures, heat is axially transferred from the second collar end toward the first collar end via at the at least one fastener more quickly than via adjacent portions of the collar member.

14. The firestop apparatus of claim 1, wherein the second end of the sleeve member and the first end of the collar member are substantially planar and are disposed on opposite sides of a separation plane positioned axially between the sleeve member and the collar member.

15. The firestop apparatus of claim 1, further comprising a gasket member having a gasket opening aligned with the sleeve opening and a laterally inner edge sized to sealingly contact the conduit member, the gasket member comprising at least one gasket fastener aperture aligned with the at least one sleeve aperture and the at least one collar fastener aperture and the at least one fastener passing through the at least one gasket fastener aperture, the gasket member being positioned axially intermediate the second end of the sleeve member and the first collar end.

16. The firestop apparatus of claim 1, wherein the collar member further comprises at least one attachment member formed from the intumescent material, the at least one attachment member configured to receive an attachment fastener to couple the firestop apparatus to a form member for containing the partition material.

17. A firestop apparatus for casting into a partition cast from a partition material, the firestop apparatus comprising:
a) a sleeve member, the sleeve member extending along a sleeve axis and having a first end, a second end axially spaced apart from the first end and a sleeve sidewall extending between the first and second ends, the sleeve member having a sleeve opening extending between the first and second ends and configured to receive a conduit member, the sleeve member comprising a laterally outer sleeve surface exposed to contact partition material surrounding the sleeve member;
b) an intumescent collar member formed from an intumescent material, the collar member having a first collar end adjacent the second end of the sleeve member, a second collar end axially spaced apart from the second collar end and a collar sidewall extending between the first and second collar ends, the collar member having a collar opening to receive the conduit member, the collar opening extending between the first and second collar ends and being aligned with the sleeve opening, the collar member comprising a laterally outer collar surface that is exposed to contact partition material cast around the sleeve member, the outer collar surface being axially spaced apart from the exposed sleeve outer surface, the collar member expandable from a non-expanded configuration to an expanded configuration, in which the intumescent collar material expands at least laterally inwardly to seal against the conduit member, when exposed to temperatures above an expansion temperature of the intumescent material.

18. The firestop apparatus of claim 17, wherein at least a portion of the laterally outer surface of the collar member is positioned laterally outboard the laterally outer surface of the sleeve portion.

19. A firestop apparatus comprising:
a) a sleeve member the sleeve member extending along a sleeve axis between a first end and a second end axially spaced apart from the first end, a sleeve sidewall extending between the first and second ends and laterally surrounding a sleeve opening extending between the first and second ends, the sleeve opening configured to receive a conduit member;
b) an intumescent collar member positioned adjacent the second sleeve end and extending axially between a first collar end and a second collar end, the collar member formed from an intumescent material that is expandable in at least the lateral and axial directions when exposed to temperatures above an expansion temperature of the intumescent material, the collar member comprising a collar sidewall portion and a plurality of collar reservoir projections extending laterally outwardly from the collar sidewall portion and spaced apart from each other around a perimeter of the collar sidewall portion, the collar sidewall portion extending between a first sidewall end face at the first collar end and a second sidewall end face at the second collar end and laterally surrounding a collar opening, the collar opening aligned with the sleeve opening and configured to receive the conduit member, each collar reservoir projection extending axially between a second projection end face at the second collar end and a first projection end face spaced apart from the second projection end, a collar fastener aperture extending axially through each reservoir projection;
c) a fastener extending through each collar fastener aperture, each fastener including a securement portion securable to at least one of the sleeve member and the partition to prevent axial movement of the fastener relative to the collar member and a head portion covering at least a portion of the second projection end face to inhibit axial expansion of the intumescent material forming the reservoir projection.

20. The firestop apparatus of claim 19, wherein the sleeve member comprises a sleeve fastener aperture aligned with each collar fastener aperture and each fastener extending through a respective sleeve fastener aperture and fastening the collar member to the sleeve member.
